(19) United States
(12) Patent Application Publication
(10) Pub. No.: US 2013/0085844 A1
(43) Pub. Date: Apr. 4, 2013

(54) SOCIAL RANKING FOR ONLINE COMMERCE SELLERS

(71) Applicants: Eugene (John) NEYSTADT, Kfar-Saba (IL); Ron Karidi, Herzeliya (IL); Avigad Oron, Tel Aviv (IL); Maxim Vainstein, Rehovot (IL)

(72) Inventors: Eugene (John) NEYSTADT, Kfar-Saba (IL); Ron Karidi, Herzeliya (IL); Avigad Oron, Tel Aviv (IL); Maxim Vainstein, Rehovot (IL)

(73) Assignee: Microsoft Corporation, Redmond, WA (US)

(21) Appl. No.: 13/252,213

(22) Filed: Oct. 4, 2011

(51) Int. Cl. G06Q 30/02

(52) U.S. Cl. 705/14.49; 705/27.1

(57) ABSTRACT

Online sellers may be ranked based on feedback given by people trusted by an individual user. The user may trust people in their social networks, as well as people who may be experts in a particular field, and the seller's ranking may be calculated by weighting reviews or feedback from trusted people higher than people unknown to the user. When used with a social campaign management system, ranking of products from multiple online sellers may include coupons or incentives that are available through the user's social network, as well as discounts or incentives that may be targeted to the user's status within their own social network.

### BACKGROUND

Online sellers vary in quality and service, but it is hard to assess which ones actually perform better than others. Many online commerce sites have rankings or feedback for different sellers, but those rankings or feedbacks may be manipulated by the sellers, who may use fictitious users to give high feedback, for example.

Many online sellers offer their wares through aggregators, which may be search engines, fulfillment centers, or other services where multiple sellers can sell products. When a user searches for products using an aggregator, the user may see several offers for the same or similar products and may be able to rank those products based on cost, for example.

### SUMMARY

Online sellers may be ranked based on feedback given by people trusted by an individual user. The user may trust people in their social networks, as well as people who may be experts in a particular field, and the seller's ranking may be calculated by weighting reviews or feedback from trusted people higher than people unknown to the user. When used with a social campaign management system, ranking of products from multiple online sellers may include coupons or incentives that are available through the user's social network, as well as discounts or incentives that may be targeted to the user's status within their own social network.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a network environment with a reputation system for sellers.

FIG. 2 is a flowchart of an embodiment showing a method for identifying influencers.

FIG. 3 is a flowchart of an embodiment showing a method for presenting products to a user.

### DETAILED DESCRIPTION

When a user searches online to find a product to purchase, online retailers or sellers may be ranked based on recommendations provided by people within the user's social network, as well as influential people who may have reviewed or recommended various sellers. The search results for the product may include a ranked list of sellers based on the recommendations, and may be tailored based on the user's social network.

Recommendations from people within a user's social network may be more influential than recommendations from people unknown to the user. The seller's ranking score may be presented in two forms: a ranking based on the general populace's recommendations and a second ranking based on people within the user's social network.

Social marketing campaigns may also be used to increase or decrease a specific offer when a user searches for a specific product or product type. Social marketing campaigns may operate by recommending products and product offers between people within a social network. When such offers exist for a particular user, those offers may be presented in the product search results and used to rank the products and product offers.

A product search engine may present attractive and trustworthy offers to a user when the user searches for products on line. The trustworthy sellers and offers may be identified from recommendations that come from the user's social network. The attractive offers may include lowest price or best performance offers, as well as special offers that may be propagated through the user's social network as part of a social marketing campaign.

For the purposes of this specification and claims, the term “social network” or “online social network” may relate to any type of computerized mechanism through which persons may connect or communicate with each other. Some social networks may be applications that facilitate end-to-end communications between users in a formal social network. Other social networks may be less formal, and may consist of a user's email contact list, phone list, mailing list, or other database from which a user may initiate or receive communication.

In some cases, a social network may facilitate one-way relationships. In such a social network, a first user may establish a relationship with a second user without having the second user's permission or even making the second person aware of the relationship. A simple example may be an email contact list where a user may store contact information for another user. Another example may be a social network where a first user “follows” a second user to receive content from the second user. The second user may or may not be made aware of the relationship. A third example may be a weblog where a first person may publish postings that are read by a second person.

In some cases, a social network may facilitate two-way relationships. In such a social network, a first user may request a relationship with a second user and the second user may approve or acknowledge the relationship so that the two-way relationship may be established. In some social networks, each relationship within the social network may be a two-way relationship. Some social networks may support both one-way and two-way relationships.

For the purposes of this specification and claims, the term “person” or “user” may refer to both natural people and other entities that operate as a “person”. A non-natural person may be a corporation, organization, enterprise, team, or other group of people.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

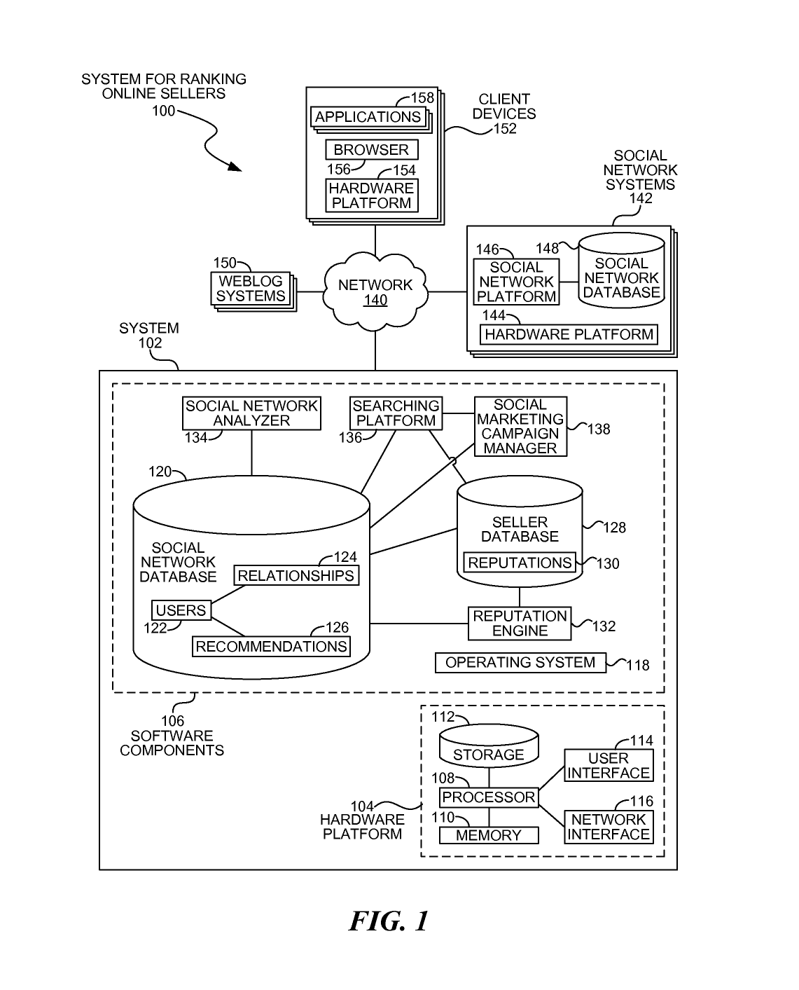

FIG. 1 is a diagram of an embodiment 100, showing a system 102 that may provide product search results that may be ranked based on information from social networks. Embodiment 100 is a simplified example of a search system that uses social network data, including social marketing campaigns, to identify products and offers that are tailored to a specific user.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 illustrates a network environment in which social network information may be incorporated into product search results. In many cases, a user may trust information provided by people within their social network more than information that may come from unfamiliar people. When a user views a recommendation from a family member, coworker, or friend, the user may trust that recommendation much more than a recommendation from an anonymous or unknown user.

Recommendations from unknown or anonymous users may be fictitious users who may be created by a marketer to inflate a product's or retailer's online reputation. Because the user has no personal affiliation or knowledge of the person who recommends a product, a user may doubt the sincerity or validity of an anonymous or unknown review.

A product search may begin by searching for multiple online retailers who provide a specific product or product type. Each retailer may be queried to identify the product and request various details about the product, such as cost, availability, shipping information, product sizes and colors, or other details. A product search engine or searching platform may gather each available product to present the results to the user.

Prior to presenting the results, the product search engine may rank the search results based in part on the recommendations of various people. The recommendations may come from anonymous or unknown users, as well as people known to the user. In order to rank the results, a search may be performed to find people within the user's social network who have recommended the product or retailer. These recommendations may be more trusted by the user than anonymous or unknown recommendations, and therefore recommendations by known individuals may be weighted higher than anonymous recommendations.

When ranking a recommendation from a person known to the user, the relationships may be further refined based on the person's expertise. For example, a person within a user's social network who is an expert in cameras may have a photography-related recommendation ranked higher than another person in the social network who does not have a known expertise in photography.

Trusted recommendations may cause certain retailers or products to be ranked higher or otherwise be presented in a more favorable light. In some cases, the recommendations may be negative, which may cause a retailer or product to be presented in a less favorable light.

Trust may be inferred through direct relationships between the user and a person known to the user. In some embodiments, trust may also be inferred through a network of relationships. For example, a person who is trusted by a friend of a user may have some assumed trust, even though the person may not have a direct relationship to the user. In such an example, the user's trusted relationship to a friend, and the friend's trusted relationship to the person may be afforded some trust value.

Results may be presented in various manners that may or may not highlight recommendations from people trusted by the user. In some cases, the presentation may include summary rankings, such as an average recommendation score. Some embodiments may include two scores: a general score based on the entire population of users who have submitted scores and a social network score based on users only within the person's social network.

The displayed rankings may allow a user to read other people's recommendations and to browse through some of the detailed information from which the rankings may be derived.

A social marketing campaign may also influence the rankings of products and sellers. A social marketing campaign may involve personal recommendations for specific products among a group of users. In a typical social marketing campaign, a coupon or special discount may be passed from one user to another, so that the recipient may receive a discount when the user makes a purchase or otherwise responds to the campaign.

When social marketing campaigns are operating within a user's social network, the offers associated with the campaigns may be presented as part of the search results for a particular product.

For example, a user may search for a digital camera. The search results may include cameras and camera vendors who are recommended by the user's friends within a social network. The search results may also include special discounts, coupons, offers, or other items that relate to a social network campaign that may be promoted by one of the user's friends. In many cases, a user who promotes a social marketing campaign may receive various financial and non-financial rewards.

In the search for a digital camera, the user may be presented with several results. The top ranked results may be those results where a user may be able to redeem a social marketing offer for a specific camera or a specific camera retailer. These results may be followed by retailers that are highly recommended by the user's friends within their social network, followed by retailers that are highly recommended by other users. This example illustrates an integrated search results page where different sets of results may be presented to the user. In some embodiments, a search results page may include just results from the social network or some subset of the various groupings of results.

A database of users may be culled from various social networks and maintained for use during a search session. A social network database may include users, their relationships with other users, and recommendations made by the users. A pre-existing database may speed up the process of finding recommendations from within a user's social network. In some embodiments, the social network database may include only influential people, rather than every person. Such an embodiment may be useful when the number of people being tracked may be very large and such an embodiment may only allocate storage space to a subset of those people.

Search results that are attributed to influencers may be given a higher factor than results attributed to non-influencers. Such an embodiment may classify different types of people into various groups, and apply different weightings to each group. In some embodiments, people within each group may have different weighting factors. For example, a group of influencers may include very strong influencers and rather weak influencers. In such an example, the strong influencers may be attributed more weight to results attributed to them while the weak influencers may have less weight. Additional weight may also be applied when the user trusts the influencer. Trust may be implied by the number and type of social network connections that the user may have with the influencer. For example, relationships that have a verified, two-way relationship between users may be valued or trusted higher than relationships that are a one-way relationship. Multiple relationships in multiple social networks may indicate a more trusted relationship as well.

Influencers may be people within a social network that have shown some type of influence. The influencers may be identified by many different criteria. The criteria may be a demonstrated knowledge in a specific field, such as maintaining a weblog that discusses certain products, commenting on other people's weblogs about certain products, or being quoted or rated in certain fields. The criteria may also include large numbers of network contacts or active usage of social networks. These are merely example criteria, and other embodiments may have more extensive criteria or methods for identifying influencers.

In many cases, a person may be considered an influencer only for certain topics, classifications, or categories. For example, a physician may be considered an influencer in medical related topics, but may not be considered an influencer in kitchen appliances.

Influencers may be classified into different types. One type may be a product maven, who may have a specific expertise in a topic. Another type of influencer may be a networker, who may have large numbers of followers who respond to the networker's suggestions. Other influencer types may also be used.

The system of embodiment 100 is illustrated as being contained in a single system 102. The system 102 may have a hardware platform 104 and software components 106.

The system 102 may represent a server or other powerful, dedicated computer system that may support multiple user sessions. In some embodiments, however, the system 102 may be any type of computing device, such as a personal computer, game console, cellular telephone, netbook computer, or other computing device.

The hardware platform 104 may include a processor 108, random access memory 110, and nonvolatile storage 112. The processor 108 may be a single microprocessor, multi-core processor, or a group of processors. The random access memory 110 may store executable code as well as data that may be immediately accessible to the processor 108, while the nonvolatile storage 112 may store executable code and data in a persistent state.

The hardware platform 104 may include user interface devices 114. The user interface devices 114 may include keyboards, monitors, pointing devices, and other user interface components.

The hardware platform 104 may also include a network interface 116. The network interface 116 may include hardwired and wireless interfaces through which the system 102 may communicate with other devices.

Many embodiments may implement the various software components using a hardware platform that is a cloud fabric. A cloud hardware fabric may execute software on multiple devices using various virtualization techniques. The cloud fabric may include hardware and software components that may operate multiple instances of an application or process in parallel. Such embodiments may have scalable throughput by implementing multiple parallel processes.

The software components 106 may include an operating system 118 on which various applications may execute. In some cloud based embodiments, the notion of an operating system 118 may or may not be exposed to an application.

The system 102 may maintain a social network database 120 that may contain various users 122, relationships between users 124, and recommendations 126 made by users. The social network database 120 may be populated by a social network analyzer 134, which may crawl various social networks, including formal and informal social networks.

The social network database 120 may be populated with a subset of all of the users in a social network. In such embodiments, the users 122 may include influencers, which may be users who have submitted recommendations or users who have demonstrated influence within social network circles.

A seller database 128 may contain reputations 130 for different online retailers. The seller database 128 may be constructed by a reputation engine 132 which may take the various recommendations 126 from the social network database 120 and create online reputations 130 for each of the various sellers.

A searching platform 136 may be a search engine that receives a request for a product, performs a search for the product, and then presents results to a user where the results may be ranked or organized based on the seller's reputation. The seller's reputation may be generated in part by recommendations created from the user's social network.

The searching platform 136 may also take into account various social marketing campaigns that may be managed by a social marketing campaign manager 138. The campaigns may include various offers, discounts, promotions, or other items that may be passed from user to user. When a search may be performed, the searching platform 136 may determine if any such promotions are being touted within a user's social network. If such promotions are available to the user, the searching platform 136 may find the promotions and make the user aware of the promotions. In some cases, such promotions may be ranked the highest within a list of search results, for example.

The system 102 may be connected through a network 140 to various social network systems 142, as well as various weblog systems 150, and client devices 152. The network 140 may be the Internet, a local area network, wide area network, a hardwired network, a wireless network, or any other type of communications network.

The social network systems 142 may operate on a hardware platform 144 and may contain a social network platform 146 that may interact with a social network database 148.

In some embodiments, the social network analyzer 134 may be able to query the social network platform 146 to retrieve information. For example, a query may request the most active users or the users with the largest number of relationships with other users. A query may identify the relationships or connections for a specific user.

The social network analyzer 134 may attempt to identify influencers from informal social networks. An informal social network may be defined by a user's contact list, subscribers to email distribution lists or Really Simple Syndication (RSS) feeds, or other lists of contacts. The social network analyzer 134 may query various weblog systems 150 or other systems to identify connections between users as well as to identify influential people.

The client devices 152 may be one mechanism by which a user may perform a query against the searching platform 136 as well as interact with the social network systems 142. The client devices 152 may be any type of device, such as a personal computer, hand held cellular telephone, notebook computer, laptop computer, tablet computer, or other device. The client devices 152 may have a hardware platform 154 on which a browser 156 or various applications 158 may execute.

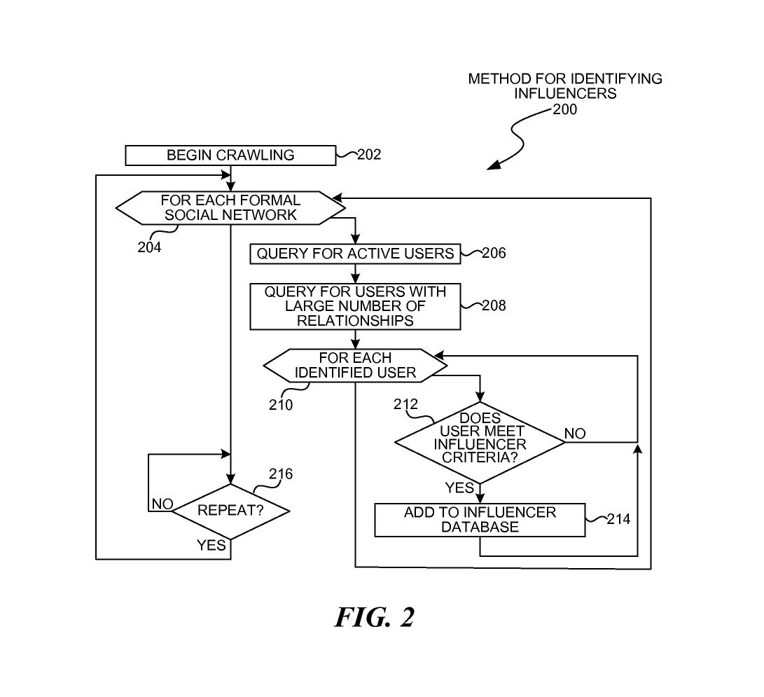

FIG. 2 is a flowchart illustration of an embodiment 200 showing a method for identifying influencers. Embodiment 200 is a simplified example of a method that may be performed by social network analyzer to crawl a social network and identify people who have influence within the social network.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 illustrates one method for identifying influential people within a social network. In some embodiments, the recommendations of influential people may be stored in a social network database. When a search is made for a product or retailer, the requester's social network may be searched to identify any recommendations for the product or retailer. In some embodiments, the recommendations of the influencers within the user's social network may be used to rank results.

Some embodiments may rank results based only on influencers within a user's social network. Other embodiments may rank results using any recommendations made by users within a user's social network. The first embodiment may be useful when the number of users in a social network may be very large, or the computational cost of searching for each user within a user's social network may cause performance delays. Such an embodiment may not take into account each and every recommendation within a user's social network. The second embodiment may be useful when the social network may be easily searched or when the number of recommendations may be few.

The process of embodiment 200 may identify influencers within the social networks. The influencers may be identified and stored in a database for responding to search requests. Such an embodiment may maintain a separate database of users from the social network, but may be much quicker in responding to requests than issuing requests against the social network directly.

In block 202, the process of crawling a social network may begin.

Each formal social network may be evaluated in block 204. For each social network, a query may be made in block 206 for the active users of the network. Another query may be made in block 208 to identify users with large numbers of relationships. Each user that was identified in blocks 206 or 208 may be processed in block 210. For each user, predefined criteria may be used to classify the user as an influencer in block 212. If the user is an influencer in block 212, the user may be added to an influencer database in block 214. If the user is not an influencer in block 212, the process may return to block 210.

After evaluating every user in block 210 and evaluating each social network in block 204, the process may wait in block 216 until repeating the analysis by returning to block 204.

Different embodiments may have different criteria for identifying a user as an influencer. In some embodiments, a user who participates in the social network or has over a predefined number of relationships may be identified as an influencer. Some embodiments may have different formulas or criteria that may take into account activities, expertise, number of relationships, or other factors.

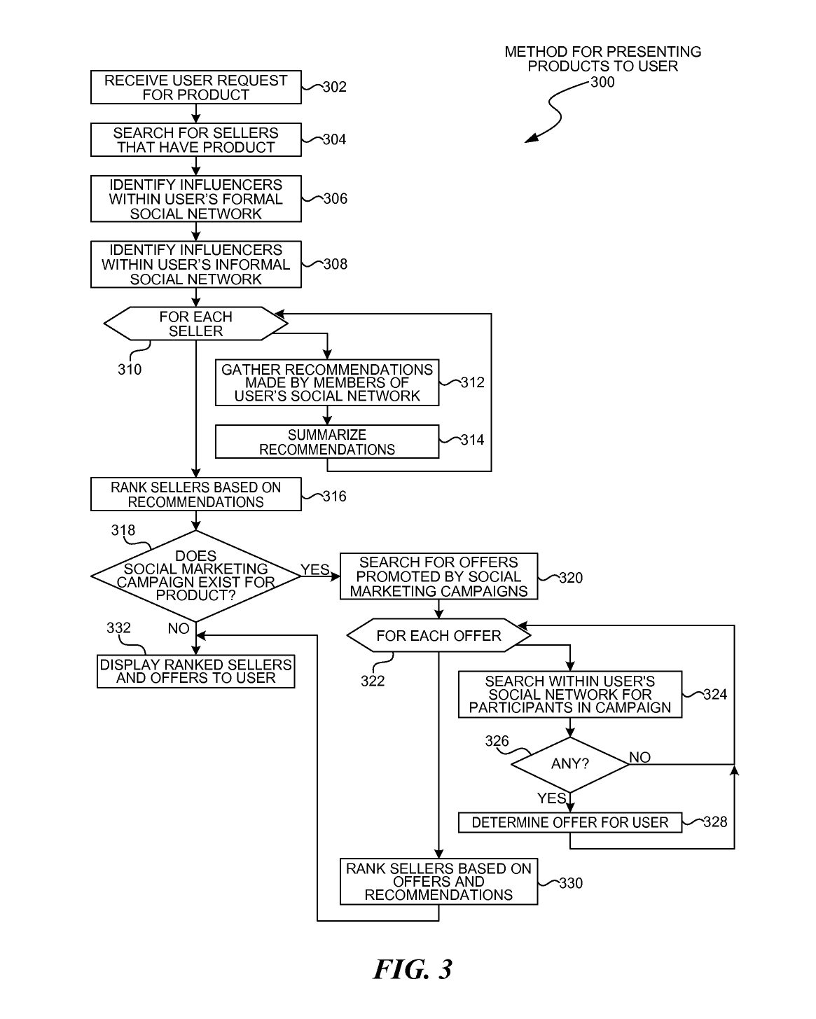

FIG. 3 is a flowchart illustration of an embodiment 300 showing a method for presenting products to a user. Embodiment 300 is a simplified example of a method that may be performed by a search platform to rank different products and retailers based on input from social networks as well as social marketing campaigns.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 is an example of how products or retailers may be ranked and presented as search results. The method of embodiment 300 may also incorporate any social marketing campaign information for the ranking, so that offers or promotions being made through a social marketing campaign may be highlighted for the user.

A user request for a search for a particular product or product type may be received in block 302. The search request may identify specific products or may identify a general class of products to search. A specific product may identify a product with a model number or specific feature, for example.

In block 304, a search may be made for sellers that may provide the requested product.

The user's formal social network may be analyzed in block 306 to identify any influencers. The influencers may be users identified using the process of embodiment 200 and may be retrieved by querying a database that contains influencers. In some embodiments, the user's formal social networks may be searched to identify other users who may have made a recommendation for one of the sellers or for the product or related products for which the user is searching. Such users may be considered influencers in this situation.

The user's informal social network may be analyzed in block 308 to also identify any influencers.

For each seller in block 310, recommendations for the seller may be gathered from the members of the user's social network in block 312. The recommendations may be summarized in block 314.

After analyzing the recommendations for all of the sellers in block 310, the sellers may be ranked based on the recommendations in block 316.

In some embodiments, the ranking may use the recommendations of influencers within the user's social network. In such embodiments, the rankings may reflect only recommendations from people who may be presumed to be known to or trusted by the user.

In some embodiments, the ranking may be a combination of recommendations by the general populace as well as recommendations by influencers known to or trusted by the user. In such embodiments, the recommendations by people within the user's social networks may be given more weight than recommendations by the general populace. Such an embodiment may be useful when the number of recommendations within the user's social network may be few.

The weightings may also be adjusted by the level of trust the user may have in the influencer. The trust may be inferred through the social network connections between the influencer and the user. Such trust may be inferred through direct relationships between the influencer and the user, or through second or third order connections between the influencer and user.

If a social marketing campaign exists for the product in block 318, a search may be made for offers being promoted within the user's social network in block 320.

For each offer in block 322, a search may be made within the user's social network for participants in the campaign. If there are none, the process may return to block 322. If a participant is found in block 326, the offer may be determined in block 328. In some cases, the offer may involve financial or non-financial rewards for the user and the user's friend within the social network.

After analyzing each offer in block 322, the sellers may be ranked in block 330 based on both the social network campaign offers and the recommendations.

The ranked sellers and offers may be presented to the user in block 332.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a social network database comprising relationships between users, at least some of said users being identified as social influencers;
a ranking system operable on at least one processor that:
receives a product identifier being searched by a user;
performs a search for said product identifier to retrieve a list of products from a plurality of sellers;
for said user, identifies a plurality of social influencers within said user's social network by analyzing said social network database;
ranks said sellers based on feedback provided by said social influencers to create a ranked list of sellers, said ranked list of sellers being specific to said user;
presents search results sorted at least in part by said ranked list of sellers.

2. The system of claim 1 further comprising:
a social network analyzer that:
analyzes a social network to identify users and relationships between users; and
identifies social influencers within said social network.

3. The system of claim 2, said social network analyzer that further:
identifies a first type of social influencer having a high degree of activity within said social network; and
identifies a second type of social influencer having a high degree of expertise in at least one field.

4. The system of claim 1 further comprising:
a social marketing campaign manager that:
identifies existing marketing campaigns for said product identifier; and
adds information about said existing marketing campaigns to said search results.

5. The system of claim 4, said information comprising offers promoted by a member of said user's social network.

6. The system of claim 4, said information comprising offers promoted by one of said sellers.

7. The system of claim 6, said offers being determined by classifying said user into one of said types of social influencers.

8. The system of claim 7, said offers being at least one of financial and non-financial incentives.

9. The system of claim 8, said offers comprising incentives to share information within a social network.

10. The system of claim 9, said information being shared being information about a first seller.

11. The system of claim 1, said product identifier being an identifier for a class of products.

12. The system of claim 1, said product identifier being an identifier for a specific product.

13. The system of claim 1, said social network database comprising relationships from a plurality of online social networks.

14. The system of claim 13, at least one of said online social networks being an informal online social network.

15. A method comprising:
receiving a product identifier being searched by a user;
searching for said product identifier from a plurality of sellers to generate a first set of search results;
for each of said plurality of sellers, determining a set of feedback from social network users;
searching a social network database comprising social influencers to determine a ranked list of social influencers for said user;
ranking said set of feedback based on said ranked list of social influencers for said user to create a ranked list of feedback;
ranking said sellers based on said ranked list of feedback; and
presenting said first list of search results sorted according to said ranked list of feedback.

16. The method of claim 15, said ranked list of social influencers comprising social influencers having a strong relationship with said user in at least one online social network.

17. The method of claim 16, said ranked list of social influencers comprising social influencers having a high degree of expertise for said product identifier.

18. A social campaign management system comprising:
a social network database comprising relationships between users, at least some of said users being identified as social influencers;
a database comprising marketing campaigns comprising incentives offered to users based on user's online activities, said marketing campaigns being offered by online sellers;
a ranking system operable on at least one processor that:
receives a product identifier being searched by a user, said user entering a search aggregating results from a plurality of online sellers;
performs a search for said product identifier to retrieve a list of products from said plurality of online sellers;
for said user, identifies plurality of social influencers within said user's social network by analyzing said social network database;
ranks said sellers based on feedback provided by said social influencers to create a ranked list of said online sellers, said ranked list of online sellers being specific to said user;
presents search results sorted at least in part by said ranked list of said online sellers; and
presents at least one of said incentives provided by a first online seller to said user.

19. The social campaign management system of claim 18, said ranking system that further:
identifies said user as a user for which a non-financial incentive is targeted, said incentive being a non-financial incentive.

20. The social campaign management system of claim 19, said ranking system that further:
identifies at least one incentive provided by a first online user having a social network relationship to said user; and
presents said at least one incentive to said user.
